(19) United States
(12) Patent Application Publication
(10) Pub. No.: US 2006/0226246 A1
(43) Pub. Date: Oct. 12, 2006

(54) Method for regulation of the operation of a vehicle auxiliary heating/auxiliary ventilation

(75) Inventors: Rolf Röhm, Jettingen (DE); Bernd Seiler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimierChrysler AG, Stuttgart (DE)

(21) Appl. No.: 10/537,270

(22) PCT Filed: Nov. 5, 2003
(86) PCT No.: PCT/EP03/12303

§ 371 Date: Mar. 22, 2006

(30) Foreign Application Priority Data
Dec. 4, 2002 (DE) 102 56 867.7

(51) Int. Cl. B60H 1/00; F24J 3/00

(52) U.S. Cl. 237/12.3 R

(57) ABSTRACT

A method for regulation of the operation of a vehicle auxiliary heating/auxiliary ventilation by making use of the heating energy provided by the auxiliary heating. The front and the rear system are activated until a certain limit temperature of the front and rear water circuit for heating or air-conditioning the vehicle interior is reached, so that the interior can be heated more rapidly and uniformly, due to the entire water circuit being heated. After the limit temperature of the front and rear water circuit is reached, only the front water circuit continues to be heated, for example, in order to defrost the windshield and to heat the front interior. If the blow-in temperature in the front interior has reached a certain threshold value or an internal deviation of a regulator lies below a predetermined further limit value, only the rear water circuit is switched on again.

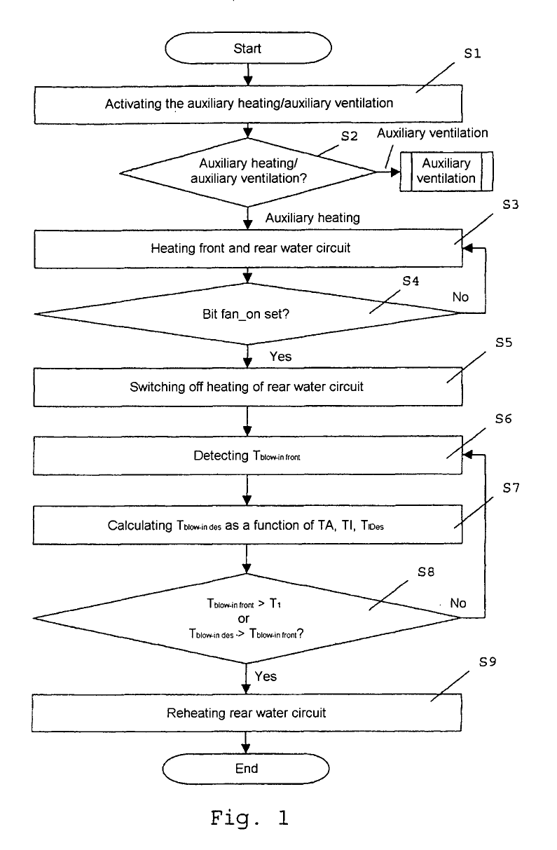

This application claims priority to International Patent Application No. PCT/EP2003/012303, filed Nov. 5, 2003, designating the United States of America, and German Application DE 102 56 867.7, filed Dec. 4, 2002, the disclosures of which is are expressly incorporated by reference herein.

### BACKGROUND AND SUMMARY OF THE INVENTION

The invention relates to a method for regulation of the operation of a vehicle auxiliary heating/auxiliary ventilation.

German Patent Document DE 197 28 724 A1 discloses an interconnected heat flow structure in motor vehicles consists of an interconnected coolant pipe system. A control unit influences the heat flows as a function of actual heat flows and desired heat flows in such a manner that the sum total of all of the heat flows emerging from functional components is approximately equal to the sum total of all of the heat flows supplied to the functional components. The functional components are a heating system, an internal combustion engine, a radiator, a latent heat store and an auxiliary heating.

In passenger vehicles of the mid-size category/full-size category, the auxiliary heating is offered either as standard or as an option in order to increase the air-conditioning comfort at a transitional time of year or in winter time. In the case of vehicles having front and rear heating, only an auxiliary heating is used, for cost reasons. Since the auxiliary heating only has a power of approx. 4.5 to 7 KW, the prior art devices, when the auxiliary heating/auxiliary ventilation has been activated, only activates the front system in order to air-condition, i.e. heat, the interior, and to de-ice the windshield. The rear system can be activated manually only via a RESIDUAL function if such a RESIDUAL function is present in a rear control panel. If the rear control panel does not have a RESIDUAL function, it is not currently possible for the heating power of the rear system to be used. If the rear system is not activated during auxiliary heating operation, only the water circuit of the front system is heated and the water circuit of the rear system remains cold.

If the engine is started in this condition, i.e. when the water in the front circuit is hot and the water in the rear circuit is cold, the mixing of the hot and cold water causes the blow-in temperature of the front system to collapse. This cooling of the blow-in temperature is very uncomfortable for the driver and front passenger.

It is therefore the object of the present invention to design a method for regulation of the operation of a vehicle auxiliary heating/auxiliary ventilation through which the above-described problem can be avoided.

The method according to the invention for regulation of the operation of a vehicle auxiliary heating/auxiliary ventilation makes optimum use of the heating energy provided by the auxiliary heating. As a result of the fact that the front and rear system is activated for heating or air-conditioning the vehicle interior, the vehicle interior can be heated or air-conditioned more rapidly and uniformly and the entire water circuit is heated. A significant increase in comfort can be achieved as a result.

This and further objects, features and advantages of the present invention become obvious from the description below of a preferred exemplary embodiment of the invention in conjunction with the drawing.

### BRIEF DESCRIPTION OF THE DRAWING

The sole FIGURE shows a flow diagram of the method according to the invention for regulation of the operation of a vehicle auxiliary heating/auxiliary ventilation.

### DETAILED DESCRIPTION OF THE DRAWING

The method according to the invention for regulation of the operation of a vehicle auxiliary heating/auxiliary ventilation will be explained in more detail below with reference to the FIGURE.

In the case of the method according to the invention for regulation of the operation of a vehicle auxiliary heating/auxiliary ventilation, first of all, in step S1, an auxiliary heating/auxiliary ventilation is activated. In this case, the activation can take place via a push-button switch, for example in a front operating panel of the vehicle, via a time preselection device which is contained, for example, in the instrument cluster, via a radio remote control or via a mobile telephone. A switching-off signal can take place via the push-button switch likewise used for switching on, via the radio remote control, the mobile telephone, via the front operating panel, via the time sequence in an auxiliary heating control unit or via an electrical system voltage in the control unit.

It is subsequently interrogated in step S2 whether there is an auxiliary heating operation or an auxiliary ventilation operation. For this purpose, a bit “auxiliary heating/auxiliary ventilation” is sent from an auxiliary heating control unit to the air-conditioning control units. On receiving this bit, each air-conditioning control unit checks with reference to the set interior temperature desired value T_{IDes}, the interior temperature actual value T_{I} and the outside temperature T_{A} whether heating or ventilation has to be carried out. If all of the air-conditioning control units come to a ventilation result, it is decided that the auxiliary ventilation operation is required. If at least one air-conditioning control unit decides that a heating operation is required, it is decided that the auxiliary heating operation is required. In the event that the auxiliary ventilation operation is present, there is branching off into an auxiliary ventilation sequence (not described specifically). If, by contrast, the auxiliary heating operation is present, a heating of the front and of the rear water circuit by the auxiliary heating takes place in step S3. It is then checked in a step S4 whether a bit fan_on is set. This bit is issued by an auxiliary heating control unit if the temperature of the front and of the rear water circuit is above a predetermined threshold value, for example 40° C. If the bit is not set, the sequence returns to step S3, so that the front and rear water circuit is heated again.

If, however, the bit is recognized in step S4 as having been set, i.e. the temperature of the front and rear water circuit is above the predetermined threshold value, in step S5 the heating of the rear water circuit is switched off and only the front water circuit continues to be heated. The heated water then remains in the rear water circuit. All of the heating energy is then used by the exclusive heating of the front water circuit to de-ice the windshield. Then, in step S6, the front blow-in temperature T_{blow-in front} is detected and, in step, the desired blow-in temperature T_{blow-in des} is calculated as a function of the outside temperature T_{A}, the actual interior temperature T_{I} and the desired interior temperature T_{IDes}.

In step S8, an evaluation of this detected front blow-in temperature T_{blow-in front} and of the calculated temperature T_{blow-in des} takes place by, for the front blow-in temperature T_{blow-in front}, a comparison with a threshold value T₁, for example 54° C., being carried out and, for the desired blow-in temperature T_{blow-in des}, a comparison with the detected front blow-in temperature T_{blow-in front} taking place, i.e. it is compared whether internal deviation by a regulator (on the right and left) has to be smaller than −10 K. In this case, the threshold value T₁ is, for example, a maximum value for the blow-in temperature. The deviation between the actual blow-in temperature T_{blow-in front} and the desired blow-in temperature T_{blow-in des} always comes about at very low outside temperatures, since the calculated desired blow-in temperature T_{blow-in des} cannot be obtained in such cases. If the front blow-in temperature T_{blow-in front} is above the predetermined threshold value T1 or the desired blow-in temperature T_{blow-in des} is above the detected blow-in temperature T_{blow-in}, a reheating of the rear water circuit takes place in step S9 to air-condition the interior. Otherwise, the sequence returns to step S6.

For the regulation according to the invention care should be taken to ensure that in winter in order to limit the desired blow-in temperature T_{blow-in des} the cooling water temperature should not be used. This is because in this case the regulation could specify a low blow-in temperature in spite of the hot heating water circuit (blow-in temperatures). Therefore, at blow-in temperatures of the front air-conditioning system of below 40° C., the desired blow-in temperatures of the rear air-conditioning system are limited to 60° C. Desired blow-in temperatures of 60° C. are specified until the blow-in conditions (desired blow-in limiting of the rear air-conditioning system) of the front air-conditioning system are active.

It is ensured that the auxiliary heating/auxiliary ventilation decision is only taken when all of the sensor values necessary for it have been correctly initialized. In this case, there is a switch-on hystereses curve.

If the auxiliary ventilation/auxiliary heating is switched on during an active RESIDUAL operation, i.e. using residual heat, the activated setting RESIDUAL is deactivated. The residual function remains blocked during active auxiliary ventilation/auxiliary heating.

In summary, the present invention discloses a method for regulation of the operation of a vehicle auxiliary heating/auxiliary ventilation. The method according to the invention makes optimum use of the heating energy provided by the auxiliary heating. For this purpose, the front and the rear system are active up to a certain limit temperature of the front and rear water circuit to heat and air-condition the vehicle interior, so that the interior can be heated more rapidly and uniformly, since the entire water circuit is heated. After the limit temperature of the front and rear water circuit is reached, only the front water circuit continues to be heated, for example in order to defrost the windshield and to heat the front interior. If the blow-in temperature in the front interior has reached a certain threshold value or an internal deviation of a regulator is below a predetermined further threshold value, only the rear water circuit is switched on again.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method for regulation of the operation of a vehicle auxiliary heating/auxiliary ventilation, comprising the steps:
activating an auxiliary heating/auxiliary ventilation,
determining vehicle interior temperature requirements,
deciding whether an auxiliary heating or auxiliary ventilation is required,
if an auxiliary ventilation is required controlling the auxiliary ventilation,
if auxiliary heating is required, heating both a front and a rear water circuit, until a first predetermined temperature is reached,
switching off the rear water circuit, when said predetermined temperature is reached;
detecting a front blow-in temperature,
calculating a desired blow-in temperature as a function of the outside temperature, actual interior temperature and a desired interior temperature,
reheating the rear water circuit if the detected front blow-in temperature exceeds a second predetermined temperature or if said front blow in temperature is less than the desired blow in temperature.

13. The method for regulation of the operation of a vehicle auxiliary heating/auxiliary ventilation as claimed in claim 12, wherein the step of heating until a first predetermined temperature in reach is determined by a bit check in an auxiliary heating control system.

14. The method for regulation of the operation of a vehicle auxiliary heating/auxiliary ventilation as claimed in claim 12, wherein said second predetermined temperature is approximately 54° C.

15. The method for regulation of the operation of a vehicle auxiliary heating/auxiliary ventilation as claimed in claim 12, wherein the step of determining interior temperature requirements is based on bit check and of a set interior desired temperature (T_{IDes}), the interior actual temperature (T_{I}) and the outside temperature (T_{A}), wherein the auxiliary heating operation is employed if at least one air-conditioning control unit decides that heating is required, and wherein an auxiliary ventilation operation only takes place if all of the air-conditioning control units decide that auxiliary ventilation is required.

16. The method for regulation of the operation of a vehicle auxiliary heating/auxiliary ventilation as claimed in claim 12, wherein said first predetermined temperature is approximately 40° C.

17. The method for regulation of the operation of a vehicle auxiliary heating/auxiliary ventilation as claimed in claim 12, wherein reheating occurs when said desired blow-in temperature exceeds the blow-in temperature by less than 10° C.

18. The method for regulation of the operation of a vehicle auxiliary heating/auxiliary ventilation as claimed in claim 12, wherein the desired blow-in temperature has a limiting value.

19. The method for regulation of the operation of a vehicle auxiliary heating/auxiliary ventilation as claimed in claim 18, wherein said limiting value is not a function of cooling water temperature when said outside temperature is less than a third predetermined value.

20. The method for regulation of the operation of a vehicle auxiliary heating/auxiliary ventilation as claimed in claim 12, wherein at blow-in temperatures of the front air-conditioning system of below 40° C., the desired blow-in temperatures of the rear air-conditioning system are limited to 60°C., the desired blow-in temperatures of the rear air-conditioning system being specified at 60° C. until the blow-in conditions of the front air-conditioning system are fulfilled.

21. The method for regulation of the operation of a vehicle auxiliary heating/auxiliary ventilation as claimed in claim 12, wherein the auxiliary heating/auxiliary ventilation decision step only takes place when all of the sensor values necessary for said decision have been correctly initialized.

22. The method for regulation of the operation of a vehicle auxiliary heating/auxiliary ventilation as claimed in claim 12, wherein a residual heating function of the air-conditioning system is deactivated during an active auxiliary ventilation/auxiliary heating operation.

23. The method for regulation of the operation of a vehicle auxiliary heating/auxiliary ventilation as claimed in claim 13, wherein said second predetermined temperature is approximately 54° C.

24. The method for regulation of the operation of a vehicle auxiliary heating/auxiliary ventilation as claimed in claim 13, wherein the step of determining interior temperature requirements is based on bit check and of a set interior desired temperature (T_{IDes}), the interior actual temperature (T_{I}) and the outside temperature (T_{A}), wherein the auxiliary heating operation is employed if at least one air-conditioning control unit decides that heating is required, and wherein an auxiliary ventilation operation only takes place if all of the air-conditioning control units decide that auxiliary ventilation is required.

25. The method for regulation of the operation of a vehicle auxiliary heating/auxiliary ventilation as claimed in claim 14, wherein the step of determining interior temperature requirements is based on bit check and of a set interior desired temperature (T_{IDes}), the interior actual temperature (T_{I}) and the outside temperature (T_{A}), wherein the auxiliary heating operation is employed if at least one air-conditioning control unit decides that heating is required, and wherein an auxiliary ventilation operation only takes place if all of the air-conditioning control units decide that auxiliary ventilation is required.

26. The method for regulation of the operation of a vehicle auxiliary heating/auxiliary ventilation as claimed in claim 15, wherein the desired blow-in temperature has a limiting value.

27. The method for regulation of the operation of a vehicle auxiliary heating/auxiliary ventilation as claimed in claim 18, wherein said limiting value is not a function of cooling water temperature when said outside temperature is less than a third predetermined value.

28. The method for regulation of the operation of a vehicle auxiliary heating/auxiliary ventilation as claimed in claim 15, wherein at blow-in temperatures of the front air-conditioning system of below 40° C., the desired blow-in temperatures of the rear air-conditioning system are limited to 60° C., the desired blow-in temperatures of the rear air-conditioning system being specified at 60° C. until the blow-in conditions of the front air-conditioning system are fulfilled.

29. The method for regulation of the operation of a vehicle auxiliary heating/auxiliary ventilation as claimed in claim 14, wherein said first predetermined temperature is approximately 40° C.

30. The method for regulation of the operation of a vehicle auxiliary heating/auxiliary ventilation as claimed in claim 14, wherein at blow-in temperatures of the front air-conditioning system of below 40° C., the desired blow-in temperatures of the rear air-conditioning system are limited to 60° C., the desired blow-in temperatures of the rear air-conditioning system being specified at 60° C. until the blow-in conditions of the front air-conditioning system are fulfilled.

31. The method for regulation of the operation of a vehicle auxiliary heating/auxiliary ventilation as claimed in claim 15, wherein a residual heating function of the air-conditioning system is deactivated during an active auxiliary ventilation/auxiliary heating operation.
